(19) United States
(12) Patent Application Publication
(10) Pub. No.: US 2025/0147199 A1
(43) Pub. Date: May 8, 2025

(54) A SYSTEM AND A METHOD OF DETECTION AND DELINEATION OF AN OBJECT THAT IS AT LEAST PARTLY BURIED IN SEABED

(71) Applicant: Argeo Robotics AS, Hvalstad (NO)

(72) Inventors: Johan Mattsson, Trångsund (SE); Thorbjørn Rekdal, Høvik (NO)

(21) Appl. No.: 18/832,469

(22) PCT Filed: Jan. 23, 2023
(86) PCT No.: PCT/NO2023/050017

§ 371 Date: Jul. 23, 2024

(30) Foreign Application Priority Data
Jan. 25, 2022 (NO) 20220116

(51) Int. Cl. G01V 3/165; B63G 8/00; G01V 3/38

(52) U.S. Cl. CPC G01V 3/165; B63G 8/001; G01V 3/38; B63G 2008/004

(57) ABSTRACT

The disclosure relates to a system for detection and delineation of an object that is at least partly buried in seabed, the system comprising: a marine vehicle (1,10); a controlled electric dipole source (3) mounted on the marine vehicle; a first receiver electrode pair (4) comprising vertical receiver electrodes (4a, 4b) mounted on the marine vehicle, the vertical receiver electrodes (4a4b) separated from one another in the vertical direction of the AUV (1); a 3 axes magnetometer assembly; wherein the receiver pair (4) is configured to measure electric field and the 3-axes magnetometer assembly is configured to measure magnetic field. The disclosure further relates to a method of detection and delineation of an object that is at least partly buried in seabed.

### TECHNICAL FIELD

The present disclosure relates to a system for detection and delineation of an object that is at least partly buried in seabed and a method of detection and delineation of an object that is at least partly buried in seabed. More specifically, the disclosure relates to a system for detection and delineation of an object that is at least partly buried in seabed and a method of detection and delineation of an object that is at least partly buried in seabed as defined in the introductory parts of claim 1 and claim 9.

### BACKGROUND ART

Scanning for buried conductive object is an important underwater survey task before establishing any installations on the seafloor. It is vital to know if there are any unwanted obstacles that need to be removed before any exploitation of the area of interest. Traditionally, passive magnetometer and gradiometer sensors are used to detect magnetized metal objects like Unexploded Ordnance (UXO). These sensors are usually mounted on frames that are towed close to the seafloor along lines that are separated with only a few meters. This method is widely used but time consuming.

Active Controlled Source ElectroMagnetic (CSEM) technologies for underwater environments have also been developed for detection of buried conductive objects like sea mines and UXOs. A CSEM method for detecting and locating buried metal objects was developed in year 2000 at the Swedish Defence Research Agency (FOI). The method consisted in a horizontal electric dipole source in combination with a vertical electrode receiver pair in the middle of the source. Some examples of the prior art include: Johan Mattsson and Peter Sigray, Electromagnetic Sea-Mine Detection, FOA-R-00-01547-409-SE, ISSN 1104-9154, 2000; and Lennart Crona, Tim Fristedt, Johan Mattsson and Peter Sigray, Sea-trials with active EM for sea-mine detection, FOA-R-00-01757-313-SE, ISSN 1104-9154, 2000. This method was also combined with acoustic measurements from a SBP sensor to determine more high-resolution structure of the buried object.

A similar CSEM method for locating underwater metal objects is disclosed in the patents WO 2006/134329 A2 and U.S. Pat. No. 8,055,193 B2.

WO 2006/134329 A2 discloses an underwater remote sensing system comprising a transmitter for transmitting an electromagnetic signal, a receiver for receiving an electromagnetic signal reflected from an object and determining means for determining the location of the object, wherein at least one of the transmitter and receiver is underwater. The determining means may be operable to determine the location of the object using signals received at three or more receiver positions. To do this, three or more receiver antennas may be provided. Alternatively, a single receiver antenna may be provided and moved between three or more different measurement locations.

U.S. Pat. No. 8,055,193 B2 discloses An underwater remote sensing system comprising a transmitter for transmitting an electromagnetic signal, a receiver for receiving an electromagnetic signal reflected from an object and determining means for determining the location of the object, wherein at least one of the transmitter and receiver is underwater. The determining means may be operable to determine the location of the object using signals received at three or more receiver positions. To do this, three or more receiver antennas may be provided. Alternatively, a single receiver antenna may be provided and moved between three or more different measurement locations.

However, the physics described in WO 2006/134329 A2 and U.S. Pat. No. 8,055,193 B2 relates to detection of a reflected wave at transmitted frequencies of 1-3 MHz. This type of physics does not work in seawater of conductivity typical to the oceans. Energy with frequencies in this region would only propagate a few meters in the water and would not reflect from an object like a reflected wave as in radar applications in air or with underwater acoustic sonars. The relevant physics is correctly described in a diffusion like manner where much lower frequencies should be used for a practical underwater CSEM sensor system for detection and localization of buried metal objects.

The mainstream approach to the interpretation of towed streamer electromagnetic (EM) data is based on 2.5-D and/or 3-D inversions of the observed data into the resistivity models of the subsurface formations. However, the rigorous 3-D and even 2.5-D inversions require large amounts of computational power and time. Synthetic aperture (SA) method is one key techniques in remote sensing using radio frequency signals. An example of this method is disclosed in Rapid Imaging of Towed Streamer EM Data Using the Optimal Synthetic Aperture Method, Michael S. Zhdanov, Daeung Yoon, and Johan Mattsson, IEEE GEOSCIENCE AND REMOTE SENSING LETTERS, VOL. 14, NO. 2, February 2017. A recently proposed CSEM method for tracking of buried pipelines is described in the patent application No. 20211242. This method is based on having an electric current dipole source implemented on an Autonomous Underwater Vehicle (AUV). The source is transmitting an electric current into the seawater at suitable frequencies and the resulting magnetic field is measured in magnetometers onboard the same AUV. The magnetic field is then used in an inversion algorithm which predicts the position of the closest part of the pipeline.

### SUMMARY

According to a first aspect there is provided a system for detection and delineation of an object that is at least partly buried in seabed, the system comprising: a marine vehicle; a controlled electric dipole source mounted on the marine vehicle; a first receiver electrode pair comprising vertical receiver electrodes mounted on the marine vehicle, the vertical receiver electrodes separated from one another in the vertical direction of the AUV; a 3 axes magnetometer assembly; wherein the receiver pair is configured to measure electric field and the 3-axes magnetometer assembly is configured to measure magnetic field.

According to some embodiments, the marine vehicle is an Autonomous Underwater Vehicle, AUV, having a hull; the AUV further comprises: a second receiver pair comprises inline receiver electrodes mounted on the hull of the hull AUV, the inline receiver electrodes are separated from one another in the longitudinal direction of the marine vehicle; and a third receiver pair 6 comprises crossline receiver electrodes mounted on the hull of the hull AUV, the receiver electrodes are separated from one another in the crossline direction of the AUV; wherein the second and the third receiver pairs are configured to measure electric field.

According to some embodiments, the controlled electric dipole source comprises at least two metal electrode plates mounted on the first end and the second end of the hull of the AUV.

According to some embodiments, the system comprises an Unmanned Surface Vehicle, USV, having a hull; the marine vehicle is a cable attached behind the USV via a towline, the cable being attached to the USV via a towline.

According to some embodiments, the controlled electric dipole source operates in the frequency range between 1 and 1000 Hz.

According to some embodiments, the system further comprises a processor which is configured to use measurements from at least one receiver electrode pair and the 3-axes magnetometer assembly to create a conductivity structure of the buried object.

According to some embodiments, a position of the buried object relative to the marine vehicle is estimated from the measured data with at least one receiver electrode pair and the 3-axes magnetometer assembly.

According to a second aspect there is provided a method of detection and delineation of an object that is at least partly buried in seabed, the method comprising steps of: transmitting electromagnetic energy from a controlled electric dipole source mounted on the hull of an Autonomous Underwater Vehicle or in a cable towed behind an Unmanned Surface Vehicle; arranging a first receiver electrode pair comprising vertical receiver electrodes mounted on the hull of the AUV or inside a cable towed behind the USV, the vertical receiver electrodes are separated from one another in the vertical direction of the AUV; measuring electric field with the receiver electrodes; measuring magnetic field with at least one 3-axes magnetometer assembly mounted in the hull of the AUV or inside a cable towed behind the USV; processing measured data with a processor located onboard of the AUV or the USV, the processor adapted to increasing sensitivity of the measured data by using Synthetic Aperture method.

According to some embodiments, the method comprises the steps: arranging a second receiver pair the method comprises inline receiver electrodes mounted on the hull of the hull AUV, the receiver electrodes are separated from one another in the longitudinal direction of the AUV or the USV; and arranging a third receiver pair comprising crossline receiver electrodes mounted on the hull of the hull AUV, the receiver electrodes are separated from one another in the crossline direction of the AUV; measuring electric field with the receiver pair electrodes mounted on the hull of the AUV.

According to some embodiments, the electromagnetic energy transmitted by the controlled electric dipole source containing discrete frequencies between 1 and 1000 Hz.

According to some embodiments, the processor by using Synthetic Aperture method normalizing the measured data with a background field and combining with optimized weights.

According to some embodiments, the Synthetic Aperture method is given as;

$$A ( w ) = {[ \frac{{d}_{A}^{( 1 )}}{{d}_{B}^{( 1 )}} , \frac{{d}_{A}^{( 2 )}}{{d}_{B}^{( 2 )}} , … , \frac{{d}_{A}^{( L )}}{{d}_{B}^{( L )}} ]}^{T}$$

$$where$$

$${d}_{A} = {E}^{N} w ,$$

$${d}_{B} = {E}^{Nb} w$$

$${E}^{N} = ( \begin{matrix}{E}_{1}^{N ( 1 )} & … & {E}_{J}^{N ( 1 )} \\ ⋮ & ⋱ & ⋮ \\ {E}_{1}^{N ( L )} & … & {E}_{J}^{N ( L )}\end{matrix} ) ,$$

$${E}^{Nb} = ( \begin{matrix}{E}_{1}^{Nb ( 1 )} & … & {E}_{J}^{Nb ( 1 )} \\ ⋮ & ⋱ & ⋮ \\ {E}_{1}^{Nb ( L )} & … & {E}_{J}^{Nb ( L )}\end{matrix} ) ,$$

$$w = {[ {w}_{1} , {w}_{2} , … , {w}_{J} ]}^{T} .$$

the matrices E^{N} and E^{Nb} containing magnetic or electric field values for controlled electric dipole source positions 1, . . . , and all receiver positions 1, . . . , L; w₁ . . . wⱼ denoted the weights.

According to some embodiments, optimizing the weights by minimizing the following function:

$$P ( w ) = {‖ D - A ( w ) ‖}^{2} + α {‖ \partial w ‖}^{2}$$

the vector D is a designed Synthetic Aperture; α is a regularization parameter; and ∂w is consecutive changes of the weights wⱼ.

According to some embodiments, obtaining conductivity structure of the buried object by feeding the processed data to a trained Convolutional Neural Network.

Effects and features of the second and third aspects are to a large extent analogous to those described above in connection with the first aspect. Embodiments mentioned in relation to the first aspect are largely compatible with the second and third aspects.

The present disclosure will become apparent from the detailed description given below. The detailed description and specific examples disclose preferred embodiments of the disclosure by way of illustration only. Those skilled in the art understand from guidance in the detailed description that changes and modifications may be made within the scope of the disclosure.

Hence, it is to be understood that the herein disclosed disclosure is not limited to the particular component parts of the device described or steps of the methods described since such device and method may vary. It is also to be understood that the terminology used herein is for purpose of describing particular embodiments only, and is not intended to be limiting. It should be noted that, as used in the specification and the appended claim, the articles “a”, “an”, “the”, and “said” are intended to mean that there are one or more of the elements unless the context explicitly dictates otherwise. Thus, for example, reference to “a unit” or “the unit” may include several devices, and the like. Furthermore, the words “comprising”, “including”, “containing” and similar wordings does not exclude other elements or steps.

### BRIEF DESCRIPTIONS OF THE DRAWINGS

The above objects, as well as additional objects, features and advantages of the present disclosure, will be more fully appreciated by reference to the following illustrative and non-limiting detailed description of example embodiments of the present disclosure, when taken in conjunction with the accompanying drawings.

FIG. 1 shows an electromagnetic data acquisition system using an Autonomous Underwater Vehicle (AUV).

FIG. 2 shows an electromagnetic data acquisition system using Unmanned Surface Vehicle (USV).

FIG. 3 shows source switching sequence for detection of buried objects.

FIG. 4 shows a vertical cross-section of the data acquisition model geometry.

FIGS. 5a, 5b, 6a, 6b show detection of a buried object using Synthetic Aperture Method processing method on computed vertical electric field E_{z} and horizontal magnetic field Bₓ.

### DETAILED DESCRIPTION

The present disclosure will now be described with reference to the accompanying drawings, in which preferred example embodiments of the disclosure are shown. The disclosure may, however, be embodied in other forms and should not be construed as limited to the herein disclosed embodiments. The disclosed embodiments are provided to fully convey the scope of the disclosure to the skilled person.

The following embodiments describes a marine vehicle, in one embodiment an Autonomous Underwater Vehicle, and in a second embodiment an Unmanned Surface Vehicle.

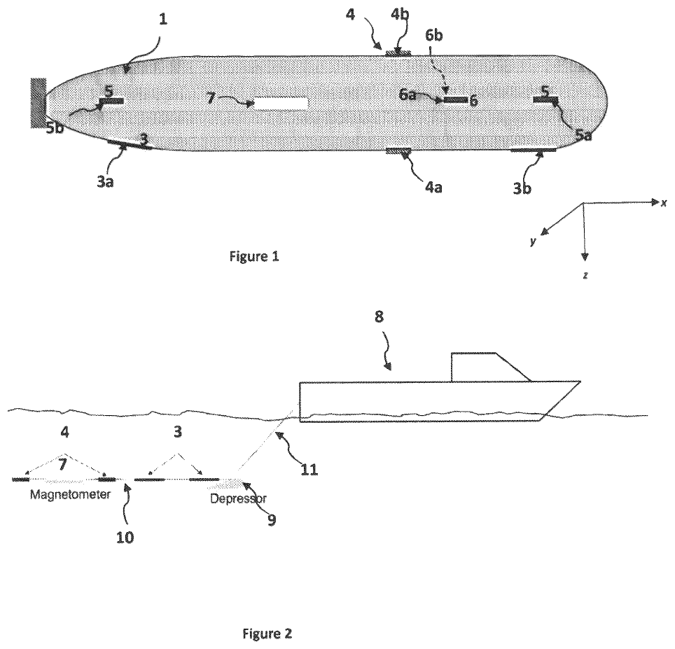

FIG. 1 shows an electromagnetic data acquisition system using an Autonomous Underwater Vehicle, referred to as AUV from hereon. The system comprises at least one AUV 1 having a hull with a first end and a second end, the AUV 1 is equipped with at least one controlled electric dipole source (CSEM) 3 comprising one or more metal electrode plates 3a, 3b mounted on the hull of the source AUV 1. In this embodiment, the electrodes are mounted on the outside of the hull, on the bottom part of the hull.

The AUV 1 further comprises sensor arrangement comprising first 4, second 5, third receiver electrode pairs 6 and at least one 3-axes magnetometer assembly 7. The first receiver electrode pair 4 comprises vertical receiver electrodes 4a, 4b mounted on the hull of the AUV 1, the receiver electrodes 4a, 4b are separated from one another in the vertical direction of the AUV 1. The second receiver pair 5 comprises inline receiver electrodes 5a, 5b mounted on the hull of the hull AUV 1, the receiver electrodes 5a, 5b are separated from one another in the longitudinal direction of the AUV 1. The third receiver pair 6 comprises crossline receiver electrodes 6a, 6b mounted on the hull of the hull AUV 1, the receiver electrodes 6a, 6b are separated from one another in the crossline direction of the AUV 1. The AUV 1 further comprises 3-axes magnetometer assembly, the 3-axes magnetometer assembly is mounted inside the hull of the AUV 1. The first, second and the third receiver pairs are configured to measure electric field and the 3-axes magnetometer assembly is configured to measure magnetic field.

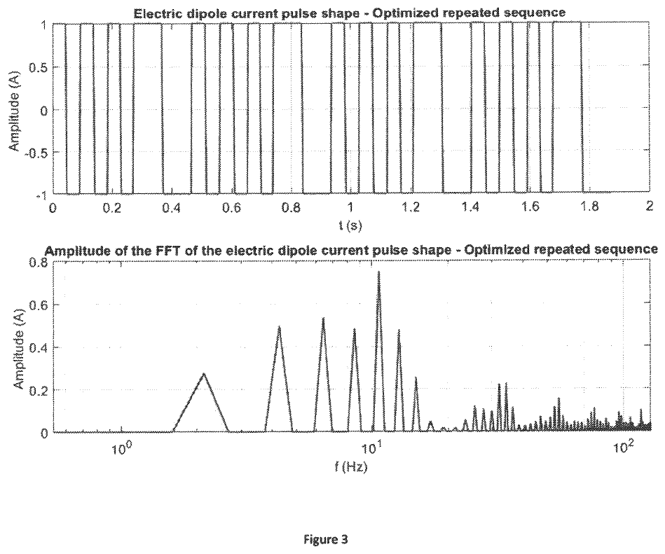

FIG. 2 shows another embodiment of the invention where the electromagnetic data is acquired using Unmanned Surface Vehicle (USV). FIG. 2 shows an USV 8 towing a cable 10, the cable comprising controlled electric dipole source 3, inline receiver electrode 4 and 3-axes magnetometer assembly 7. The cable 10 is connected to a depressor 9, which is configured to control the towing depth of the cable 10. The cable 10 and the depressor 9 are attached to the USV 8 with a towline 11. It is possible to combine the embodiment shown in FIG. 1 and the embodiment shown in FIG. 2. The cable may further be equipped with receiver electrode pairs 5 and 6.

The receiver electrodes and magnetometers are electrically connected to a measurement electronics unit and the source is electrically connected to a source electronics. Both source electronics and the measurement electronics are confined inside the AUV 1 or onboard USV 8. The source and the measurement electronics are galvanically separated from one another. The energy needed for running the source and receivers are taken from a battery onboard the AUV or USV.

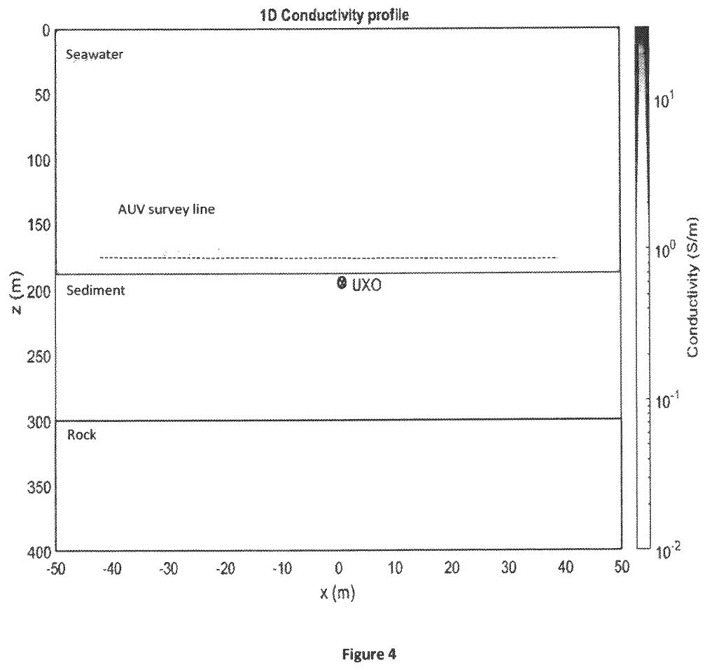

The controlled electric dipole source 3 output sequences are designed to have frequency spectra with frequencies that are sensitive to buried objects. This means that the transmitted electric current creates magnetic and electric fields that will change in amplitude and phase at these frequencies when the controlled electric dipole source 3 output sequence is passing nearby the buried object. A source sequence is created by switching the output polarity between plus and minus. An example is shown in FIG. 3. In this case, the switching sequence is 2 seconds long, top panel, and contains distinct frequency peaks between 2 and 15 Hz, amplitude frequency spectrum in the lower panel.

When acquiring electromagnetic data, the source AUV 1 and/or USV 8 are set up to run in an in-line configuration, in which the source AUV 1 and/or the USV 8 are operated to move along suitably defined survey lines covering an area of interest.

The survey lines are parallel to the inline receiver electrodes 5a, 5b (x-direction), so that the second pair of inline receiver electrodes 5a, 5b measure the electric field parallel to the survey lines 1. The first receiver pair 4a, 4b are configured to measure the vertical components of the electric field. The third receiver pair 6a, 6b are configured to measure AUV 3 is configured the y components of the electric field. The system may further comprise a processor, which is configured to use measurements from the receivers to generate a conductivity map/structure of the conductive bodies at the area of interest.

The electric and magnetic fields are continuously measured at a sampling rate <300 Hz when the AUV 1 or USV 8 is moving along a survey line. The measured electromagnetic data after a completed survey line is deconvolved with the source sequences in the frequency domain at the frequency peaks to obtain frequency responses at these frequencies. The frequency responses will vary with the conductivity in the marine environment. Hence, if a highly conductive object is in the range of sensitivity to the controlled electric dipole source output, the frequency responses will change significantly.

It is crucial that the electric and magnetic data is sufficiently sensitive for the buried object of interest to detect and locate it accurately. The detection sensitivity also put constraints on the spatial sampling frequency along and between survey lines. The height above the seafloor is also a critical parameter for a successful survey. A poor sensitivity to the buried objects forces the controlled electric dipole source output to be close to the seafloor.

An efficient way that allows for significantly higher sensitivity in the CSEM data without a decrease in the signal to noise ratio is the synthetic aperture method, referred to as SA from hereon. In this method, the acquired electromagnetic data is normalized with a background field and combined with optimized weights. In essence, a SA expression is derived and is mathematically stated as:

$$A ( w ) = {[ \frac{{d}_{A}^{( 1 )}}{{d}_{B}^{( 1 )}} , \frac{{d}_{A}^{( 2 )}}{{d}_{B}^{( 2 )}} , … , \frac{{d}_{A}^{( L )}}{{d}_{B}^{( L )}} ]}^{T}$$

$$where$$

$${d}_{A} = {E}^{N} w ,$$

$${d}_{B} = {E}^{Nb} w$$

$${E}^{N} = ( \begin{matrix}{E}_{1}^{N ( 1 )} & … & {E}_{J}^{N ( 1 )} \\ ⋮ & ⋱ & ⋮ \\ {E}_{1}^{N ( L )} & … & {E}_{J}^{N ( L )}\end{matrix} ) ,$$

$${E}^{Nb} = ( \begin{matrix}{E}_{1}^{Nb ( 1 )} & … & {E}_{J}^{Nb ( 1 )} \\ ⋮ & ⋱ & ⋮ \\ {E}_{1}^{Nb ( L )} & … & {E}_{J}^{Nb ( L )}\end{matrix} ) ,$$

$$w = {[ {w}_{1} , {w}_{2} , … , {w}_{J} ]}^{T} .$$

The matrices E^{N} and E^{Nb} contain normalized magnetic or electric field values for all source positions 1, . . . , J and all receiver positions 1, . . . , L. The weights are denoted as w₁ . . . w_{J}.

The synthetic aperture along all receiver positions is called SA without steering when the weights w are all equal to 1. This is the data with original sensitivity. To increase the sensitivity, the weights are optimized by minimizing the following functional:

$$P ( w ) = {‖ D - A ( w ) ‖}^{2} + α {‖ \partial w ‖}^{2} .$$

The vector D is a designed SA, α a regularization parameter and Ow the consecutive changes of the weights wⱼ.

An example with the SA method and a demonstration of the sensitivity increase is shown in the sections below.

The feasibility of the invention is demonstrated here in a modelling case where detection ranges to a representative buried conductive object is computed and plotted. The SA method, explained above, is used to enhance the sensitivity and hence allowing for a sparser set of survey lines.

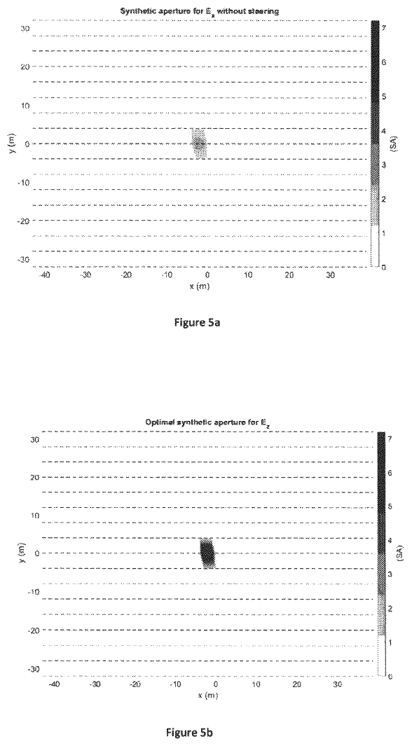

The modelling case has a one dimensional environment as shown in FIG. 4. In FIG. 4, a highly conductive object 12 of size 1.2×0.3×0.3 is buried 1.5 m below the seafloor 13 at x=y=0. The conductivity of the body is representative for iron. An electric dipole source in the x-direction, with a strength of 500 Am and a frequency of 10 Hz is run along a set of survey lines 14 at a height of 10 m above the seafloor 13. The vertical electric field component E_{z} and the horizontal magnetic field component Bₓ are computed at the same height but with an offset to the source of 3 m. In a practical measurement setup, the source and receivers would be on the same AUV 1 or towed behind the USV 8 as described above. It should also be mentioned that both of these electric and magnetic vector components are possible to measure in reality although not shown here.

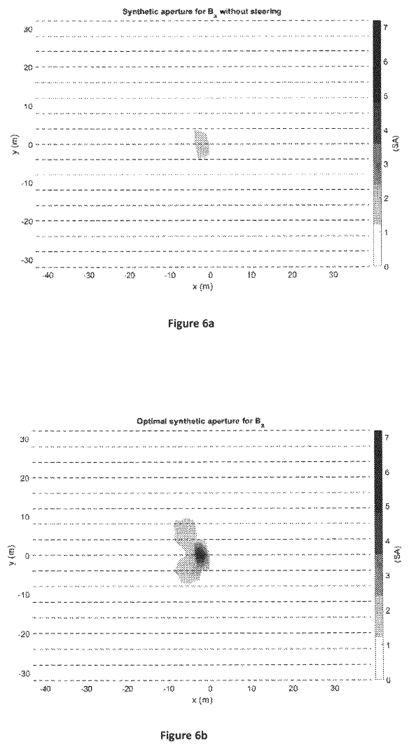

FIGS. 5a, 5b, 6a, 6b show detection of a buried iron object using SA processing on the computed vertical electric field E_{z} and horizontal magnetic field Bₓ. The number of survey lines 14 are 17 and separated by 4 m. They are marked as horizontal dashed lines in FIGS. 5 and 6. The E_{z} and Bₓ field components are sampled at every meter along each of the lines. This dense sampling and dense set of lines is used for making the resulting detection results as smooth as possible. From the results, it can then be concluded how dense the lines need to be.

The E_{z} and Bₓ field components are normalized with representative background fields, i.e. with the E_{z} and Bₓ fields outside the sensitivity range to the buried object. The resulting normalized quantities are then used in the expression for the SA. Hence, a SA vector is formalized for each of the field components and for each of the survey lines. The results are visualized as discrete grey scale plots in FIGS. 5 and 6. FIGS. 5a and 6a show plots with the weights equal to one, i.e. no steering, and the FIGS. 5b and 6b show plots of the optimized SA where the weights have been computed by minimizing the objective function described above.

It can be seen that the sensitivity strength is increased in general with the optimized weights. It is increase by a factor 3-4 when being right on top of the buried object. This enables an increase of the height of the CSEM system above the seafloor. Furthermore, it can also be seen that the horizontal sensitivity is increased in both the x- and y-directions for the Bₓ in FIG. 6b. In particular, the sensitivity range is doubled in both directions.

It can be noted that the magnetic field component Bₓ is the most sensitive to a buried object after optimization of the weights in the SA expression. It would be possible to have a line separation between 15-20 m when optimized SA has been applied to the Bₓ data. It would probably also be possible to increase the height above the seafloor from 10 m to something higher and still be able to detect the buried object.

The first aspect of this disclosure shows a system for detection and delineation of an object that is at least partly buried in seabed, the system comprising: a marine vehicle the th aspect, 10; a controlled electric dipole source 3 mounted on the marine vehicle; a first receiver electrode pair 4 comprising vertical receiver electrodes 4a,4b mounted on the marine vehicle, the vertical receiver electrodes 4a4b separated from one another in the vertical direction of the AUV 1; a 3 axes magnetometer assembly; wherein the receiver pair 4 is configured to measure electric field and the 3-axes magnetometer assembly is configured to measure magnetic field.

The marine vehicle is an Autonomous Underwater Vehicle 1, AUV, having a hull; the AUV further comprises: a second receiver pair 5 comprises inline receiver electrodes 5a,5b mounted on the hull of the hull AUV 1, the inline receiver electrodes 5a,5b are separated from one another in the longitudinal direction of the marine vehicle 1,10; and a third receiver pair 6 comprises crossline receiver electrodes 6a,6b mounted on the hull of the hull AUV 1, the receiver electrodes 6a,6b are separated from one another in the crossline direction of the AUV 1; wherein the second and the third receiver pairs are configured to measure electric field.

The controlled electric dipole source comprises at least two metal electrode 3a,3b plates mounted on the first end and the second end of the hull of the AUV.

The system comprises an Unmanned Surface Vehicle 8, USV, having a hull; the marine vehicle is a cable 10 attached behind the USV 8 via a towline 11, the cable 10 being attached to the USV via a towline 11.

The second aspect of this disclosure shows a system for detection of an object that is at least partly buried in seabed, the system comprising: Unmanned Surface Vehicle USV the th aspect having a hull; A cable 10 attached behind the USV 8 via a towline 11, the cable 10 attached to the USV via a towline 11; the cable comprising a controlled electric dipole source 3; at least one receiver electrode pair 4; at least one 3 axes magnetometer assembly; wherein the receiver electrode pair is configured to measure electric field and the 3-axes magnetometer assembly is configured to measure magnetic field.

The controlled electric dipole source operates in the frequency range between 1 and 1000 Hz.

The system further comprises a processor which is configured to use measurements from at least one receiver electrode pair and the 3-axes magnetometer assembly to create a conductivity structure of the buried object.

Position of the buried object relative to the marine vehicle 1,10 is estimated from the measured data with at least one receiver electrode pair and the 3-axes magnetometer assembly.

The second aspect of this disclosure shows a method of detection and delineation of an object that is at least partly buried in seabed, the method comprising steps of: transmitting electromagnetic energy from a controlled electric dipole source the first aspect mounted on the hull of an Autonomous Underwater Vehicle 1 or in a cable 10 towed behind an Unmanned Surface Vehicle 8; arranging a first receiver electrode pair 4 comprising vertical receiver electrodes 4a,4b mounted on the hull of the AUV 1 or inside a cable 10 towed behind the USV 8, the vertical receiver electrodes 4a,4b are separated from one another in the vertical direction of the AUV 1; measuring electric field with the receiver electrodes 4; measuring magnetic field with at least one 3-axes magnetometer assembly 7 mounted in the hull of the AUV 1 or inside a cable 10 towed behind the USV 8; processing measured data with a processor located onboard of the AUV 1 or the USV 8, the processor adapted to increasing sensitivity of the measured data by using Synthetic Aperture method.

Arranging a second receiver pair 5 the method comprises inline receiver electrodes 5a,5b mounted on the hull of the hull AUV 1, the receiver electrodes 5a5b are separated from one another in the longitudinal direction of the AUV 1 or the USV 8; and arranging a third receiver pair 6 comprising crossline receiver electrodes 6a,6b mounted on the hull of the hull AUV 1, the receiver electrodes 6a6b are separated from one another in the crossline direction of the AUV 1; measuring electric field with the receiver pair electrodes 4a,4b,5a,5b,6a,6b mounted on the hull of the AUV 1.

The electromagnetic energy transmitted by the controlled electric dipole source containing discrete frequencies between 1 and 1000 Hz.

The processor by using Synthetic Aperture method normalizing the measured data with a background field and combining with optimized weights.

The Synthetic Aperture method is given as;

$$A ( w ) = {[ \frac{{d}_{A}^{( 1 )}}{{d}_{B}^{( 1 )}} , \frac{{d}_{A}^{( 2 )}}{{d}_{B}^{( 2 )}} , … , \frac{{d}_{A}^{( L )}}{{d}_{B}^{( L )}} ]}^{T}$$

$$where$$

$${d}_{A} = {E}^{N} w ,$$

$${d}_{B} = {E}^{Nb} w$$

$${E}^{N} = ( \begin{matrix}{E}_{1}^{N ( 1 )} & … & {E}_{J}^{N ( 1 )} \\ ⋮ & ⋱ & ⋮ \\ {E}_{1}^{N ( L )} & … & {E}_{J}^{N ( L )}\end{matrix} ) ,$$

$${E}^{Nb} = ( \begin{matrix}{E}_{1}^{Nb ( 1 )} & … & {E}_{J}^{Nb ( 1 )} \\ ⋮ & ⋱ & ⋮ \\ {E}_{1}^{Nb ( L )} & … & {E}_{J}^{Nb ( L )}\end{matrix} ) ,$$

$$w = {[ {w}_{1} , {w}_{2} , … , {w}_{J} ]}^{T} .$$

the matrices E^{N} and E^{Nb} containing magnetic or electric field values for controlled electric dipole source positions 1, . . . , J and all receiver positions 1, . . . , L; w₁ . . . w_{J} denoted the weights.

Optimizing the weights by minimizing the following function:

$$P ( w ) = {‖ D - A ( w ) ‖}^{2} + α {‖ \partial w ‖}^{2}$$

the vector D is a designed Synthetic Aperture; α is a regularization parameter; and ∂w is consecutive changes of the weights wⱼ. Obtaining conductivity structure of the buried object by feeding the processed data to a trained Convolutional Neural Network.

The person skilled in the art realizes that the present disclosure is not limited to the preferred embodiments described above. The person skilled in the art further realizes that modifications and variations are possible within the scope of the appended claims. Additionally, variations to the disclosed embodiments can be understood and effected by the skilled person in practicing the claimed disclosure, from a study of the drawings, the disclosure, and the appended claims.

1-15. (canceled)

16. A system for detection and delineation of an object that is at least partly buried in seabed, the system comprising:
an Autonomous Underwater Vehicle, AUV, having a hull;
a controlled electric dipole source mounted on the hull of the AUV;
a first receiver electrode pair comprising vertical receiver electrodes mounted on the AUV, the vertical receiver electrodes separated from one another in a vertical direction of the hull of the AUV,
a 3-axes magnetometer assembly mounted in the hull of the AUV, wherein the receiver pair is configured to measure electric field and the 3-axes magnetometer assembly is configured to measure magnetic field;
a second receiver pair comprises inline receiver electrodes mounted on the hull of the AUV, the inline receiver electrodes are separated from one another in a longitudinal direction of the AUV; and
a third receiver pair comprises crossline receiver electrodes mounted on the hull of the AUV, the crossline receiver electrodes are separated from one another in a crossline direction of the AUV,
wherein the second and the third receiver pairs are configured to measure electric field.

17. The system according to claim 16, wherein the controlled electric dipole source comprises at least two metal electrode plates mounted on a first end and a second end of the hull of the AUV.

18. The system according to claim 16, wherein the controlled electric dipole source operates in the frequency range between 1 and 1000 Hz.

19. The system according to claim 16, wherein the system further comprises a processor which is configured to use measurements from at least one receiver electrode pair and the 3-axes magnetometer assembly to create a conductivity structure of a buried object.

20. The system according to claim 19, wherein the processor is configured to increase sensitivity of measured data by using a Synthetic Aperture method.

21. The system according to claim 16, wherein a position of a buried object relative to the AUV is estimated from data measured with at least one receiver electrode pair and the 3-axes magnetometer assembly.

22. A method of detection and delineation of an object that is at least partly buried in seabed, the method comprising steps of:
transmitting electromagnetic energy from a controlled electric dipole source mounted on a hull of an Autonomous Underwater Vehicle, AUV;
arranging a first receiver electrode pair comprising vertical receiver electrodes mounted on the hull of the AUV, the vertical receiver electrodes separated from one another in a vertical direction of the AUV;
arranging a second receiver pair comprising inline receiver electrodes mounted on the hull of the AUV, the inline receiver electrodes separated from one another in a longitudinal direction of the AUV;
arranging a third receiver pair comprising crossline receiver electrodes mounted on the hull of the AUV, the crossline receiver electrodes separated from one another in the crossline direction of the AUV;
measuring electric field with the first receiver electrode pair, the second receiver pair, and the third receiver pair mounted on the hull of the AUV;
measuring magnetic field with at least one 3-axes magnetometer assembly mounted in the hull of the AUV; and
processing measured data with a processor located onboard of the AUV, the processor adapted to increasing sensitivity of the measured data by using a Synthetic Aperture method.

23. The method according to claim 22, wherein the electromagnetic energy transmitted by the controlled electric dipole source comprises discrete frequencies between 1 and 1000 Hz.

24. The method according to claim 22, wherein using the Synthetic Aperture method comprises normalizing the measured data with a background field and combining with optimized weights.

25. The method according to claim 24, wherein the Synthetic Aperture method is given as;
$$A ( w ) = {[ \frac{{d}_{A}^{( 1 )}}{{d}_{B}^{( 1 )}} , \frac{{d}_{A}^{( 2 )}}{{d}_{B}^{( 2 )}} , … , \frac{{d}_{A}^{( L )}}{{d}_{B}^{( L )}} ]}^{T}$$
$$where$$
$${d}_{A} = {E}^{N} w ,$$
$${d}_{B} = {E}^{Nb} w$$
$${E}^{N} = ( \begin{matrix}{E}_{1}^{N ( 1 )} & … & {E}_{J}^{N ( 1 )} \\ ⋮ & ⋱ & ⋮ \\ {E}_{1}^{N ( L )} & … & {E}_{J}^{N ( L )}\end{matrix} ) ,$$
$${E}^{Nb} = ( \begin{matrix}{E}_{1}^{Nb ( 1 )} & … & {E}_{J}^{Nb ( 1 )} \\ ⋮ & ⋱ & ⋮ \\ {E}_{1}^{Nb ( L )} & … & {E}_{J}^{Nb ( L )}\end{matrix} ) ,$$
$$w = {[ {w}_{1} , {w}_{2} , … , {w}_{J} ]}^{T} .$$
the matrices E^{N} and E^{Nb} containing magnetic or electric field values for controlled electric dipole source positions 1, . . . , J and all receiver positions 1, . . . , L;
and w₁ . . . w_{J} denoting weights.

26. The method according to claim 25, further comprising:
obtaining conductivity structure of a buried object by feeding the processed data to a trained Convolutional Neural Network.

27. The method according to claim 24, wherein optimizing the weights comprises minimizing the following function:
$$P ( w ) = {‖ D - A ( w ) ‖}^{2} + α {‖ \partial w ‖}^{2}$$
wherein the vector D is a designed Synthetic Aperture,
α is a regularization parameter, and
∂w is consecutive changes of the weights wⱼ.
